(19) United States
(12) Patent Application Publication
(10) Pub. No.: US 2014/0091949 A1
(43) Pub. Date: Apr. 3, 2014

(54) Wireless Networks for Sharing Road Information

(71) Applicants: Omesh Tickoo, Portland, OR (US); Ravishankar Iyer, Portland, OR (US)

(72) Inventors: Omesh Tickoo, Portland, OR (US); Ravishankar Iyer, Portland, OR (US)

(21) Appl. No.: 13/993,333

(22) PCT Filed: Dec. 30, 2011
(86) PCT No.: PCT/US11/68097

§ 371 Date: Jun. 12, 2013

(51) Int. Cl. G08G 1/0967

(52) U.S. Cl. CPC G08G 1/096791
USPC 340/905

(57) ABSTRACT

An ad hoc network may be established between vehicles using a wireless connection. The wireless network may be used for sending and receiving information about road conditions, such as average speed, a location and configuration of a road obstruction, images of an accident scene, and a traffic flow plan. The wireless network may also be used for communicating with emergency response vehicles in order to enable faster and more effective responses to accidents.

### BACKGROUND

This relates generally to wireless networks for mobile devices.

A mobile device can use a wireless communication technology to establish a network connection to another mobile device. The wireless network connection enables the mobile devices to communicate with each other.

### BRIEF DESCRIPTION OF THE DRAWINGS

Some embodiments are described with respect to the following figures:

FIG. 1 is a depiction of a portion of an ad hoc wireless network in accordance with one embodiment of the present invention;

FIGS. 2A-2B are examples of an ad hoc wireless network in accordance with one embodiment of the present invention;

FIGS. 3A-3B are flow charts in accordance with one embodiment of the present invention;

FIG. 4 is a flow chart in accordance with one embodiment of the present invention; and

FIG. 5 is a schematic depiction of a node in accordance with one embodiment of the present invention.

### DETAILED DESCRIPTION

In accordance with some embodiments, a temporary network may be established between vehicles (“nodes”) using wireless connections. Such temporary networks established between nodes may be referred to as “ad hoc wireless networks.” In one or more embodiments, an ad hoc wireless network may be used for sending and receiving information about road conditions. Such road information may include an average speed for a particular portion of road, a location and configuration of a road obstruction (e.g., a disabled vehicle), images of an accident scene, a traffic flow plan to route vehicles around a road obstruction, etc. In this manner, vehicles may avoid or reduce delays due to road congestion or obstruction.

Further, in one or more embodiments, the ad hoc wireless network may enable emergency response vehicles to assess an accident before arriving at the accident scene. Emergency response personnel may also use the ad hoc wireless network to send instructions to vehicles at or near the accident scene. In this manner, embodiments may enable faster and more effective responses to accidents.

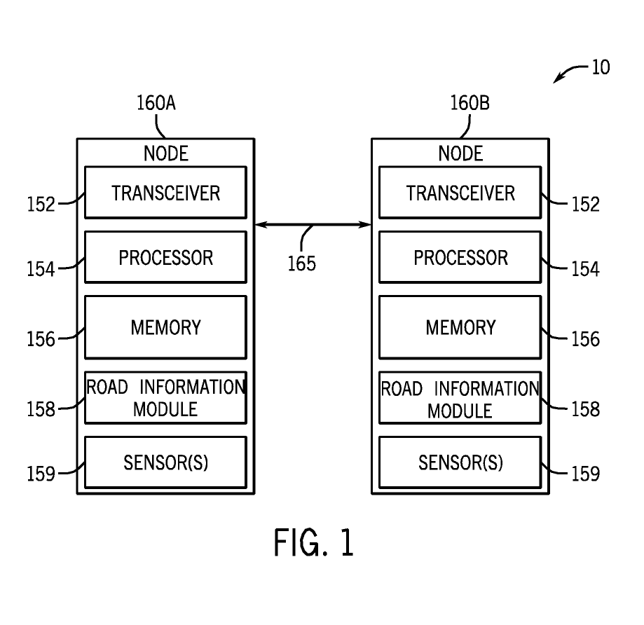

Referring to FIG. 1, an ad hoc wireless network 10 may include any number of nodes 160 (e.g., nodes 160A, 1608) connected by a wireless connection 165. The nodes 160 may be any vehicles including wireless communications interfaces. For example, a node 160 may be an automobile including a built-in computer and transceiver, a truck including a portable communication device (e.g., a cellular telephone, a laptop computer or a handheld computer), etc.

In one or more embodiments, each node 160 may include a transceiver 152, a processor 154, a memory device 156, a road information module 158, and sensor(s) 159. Further, each node 160 may have a transmission range, meaning a physical distance over which the included transceiver 152 can effectively send or receive radio transmissions to another device. Generally, a node 160 may establish a wireless connection 165 to another node 160 if the two nodes 160 are within each other's transmission ranges.

Further, in one or more embodiments, if a first node (e.g., node 160A) is out of transmission range of a second node (e.g., node 160B), the first and second nodes may instead connect to each other through one or more intervening nodes (not shown). The intervening nodes may each act as a relay station or repeater, thus enabling the first node to connect to the second node indirectly.

The wireless connections 165 may be based on any radio communications technologies and/or standards. For example, the wireless connection 165 may be a Wi-Fi connection conforming to the IEEE (Institute of Electrical and Electronics Engineers) 802.11 standard, IEEE 802.11-2007, published Jun. 12, 2007.

In one or more embodiments, the road information module 158 may include functionality to discover other nodes 160 with which to establish an ad hoc wireless network. Such functionality may include broadcasting a beacon to invite other nodes 160 to join or establish an ad hoc wireless network. In addition, such functionality may include accepting a beacon received from another node 160.

In one or more embodiments, the road information module 158 may also include functionality to determine whether to establish an ad hoc wireless network (or join an existing network) based on an estimated time duration of a wireless connection (i.e., how long the node 160 is expected to maintain the wireless connection 165 to the other node(s) 160). For example, the time duration may be estimated by determining the amount of time that will elapse before one node 160 physically moves out of the transmission range of the other node 160. This determination may involve predicting the future movements of each node based on the current speed, direction, planned path, and/or destination location of each node 160. The predicted movements may then be used to estimate a point in time (if any) when at least one node 160 moves out of the transmission range of another node 160. In one or more embodiments, the ad hoc wireless network may be established (or is joined) if the estimated time duration exceeds some predefined minimum time of connection (e.g., ten minutes, one hour, etc.).

In one or more embodiments, the road information module 158 may interact with the sensor(s) 159. The sensor(s) 159 may be any device to collect information about the node 160 or its surroundings. The information about the node 160 may include the speed, direction, destination, and planned path of the node 160. For example, the sensor(s) 159 may include a Global Positioning System (GPS) device, an onboard trip computer, a speedometer, a compass, etc. The information about the node 160 may also include a transmission range and signal strength for the node 160. For example, the sensor(s) 159 may also include a radio signal analysis device, a network bandwidth analysis device, etc.

The information about the surroundings of node 160 may include information about the physical configuration of the space around the node 160. Such spatial information may include the number and layout of lanes of the road, the positions and/or speeds of any neighboring vehicles, the position and geometry of a road obstruction (e.g., a fallen tree, a vehicle accident, a construction site), etc. For example, the sensor(s) 159 may also include a camera to capture images of the surroundings (e.g., video camera, still camera, stereoscopic camera), a light-based object-detection system (e.g., a laser, infrared, or ultraviolet emitter and/or detector), a radio-based object-detection system (e.g., active and/or passive radar), a sound-based object-detection system (e.g., active and/or passive sonar), etc.

In one or more embodiments, the information about the surroundings of node 160 may relate to the road surface and/or traction characteristics. For example, the sensor(s) 159 may include a tire traction sensor, a road ice sensor, etc. Further, it is contemplated that the sensor(s) 159 may be any other device or combination of devices configured to capture any other information about the node 160 or its surroundings.

In one or more embodiments, the road information module 158 may include functionality to analyze and/or summarize information derived from the sensor(s) 159. For example, the road information module 158 may use information about vehicle speed and road configuration to determine that a particular lane is obstructed at a specific location. The road information module 158 may also include functionality to present the information and/or an analysis thereof to a user of the node 160. For example, the road information module 158 may interact with a display device or user interface (not shown) to present a summary of the information to a user. Further, in one or more embodiments, the road information module 158 may include functionality to send such information and/or an analysis thereof to other nodes 160 using the ad hoc wireless network.

In one or more embodiments, the road information module 158 of a first node 160A may include functionality to receive inbound road information from a second node 1608, and to present the received inbound road information to a user of the first node 160A. The road information module 158 may also include functionality to determine an alternate route based on road condition information received from another node, and to present the alternate route to a user of the receiving node (e.g., a driver of a vehicle). For example, the road information module 158 of node 160A may receive information from node 1608 via the transceiver 152, and may then interact with a display device or user interface (not shown) to present the information to a user of node 160A.

In one or more embodiments, the road information module 158 of a node 160 may include functionality to send information about an accident to an emergency response vehicle using an ad hoc wireless network. For example, in the event of an accident, an emergency response vehicle may be travelling to the scene of the accident. In such a situation, receiving information about the accident from a node may enable personnel of the emergency response vehicle to assess the accident and to prepare before arriving at the accident scene. The road information module 158 of a node 160 may also include functionality to receive instructions from the emergency response vehicle, and to present the received instructions to a user of the node 160. For example, the road information module 158 of node 160 may receive instructions from the emergency response vehicle via the transceiver 152, and may then interact with a display device or user interface (not shown) to present the instructions to a user of node 160A.

In one or more embodiments, the road information module 158 of a node 160 may include functionality to determine a traffic flow plan, and to present the traffic flow plan to a user of the node 160. The traffic flow plan may specify how vehicles are to move around an obstruction in a road. In one or more embodiments, the road information module 158 may automatically determine a traffic flow plan based on predefined algorithms to improve flow through a bottleneck (e.g., merging one vehicle at a time, merging groups of a specified size, merging each lane for a specified period of time, etc.). The traffic flow plan may be determined by a single node 160 (e.g., by the first node 160 to detect the obstruction, by a randomly chosen node 160, etc.), or may be determined cooperatively among multiple nodes 160 (e.g., by automatic voting of each node 160, by user-specified voting in a user interface, etc.).

The road information module 158 may be implemented in hardware, software, and/or firmware. In firmware and software embodiments it may be implemented by computer executed instructions stored in a non-transitory computer readable medium, such as an optical, semiconductor, or magnetic storage device.

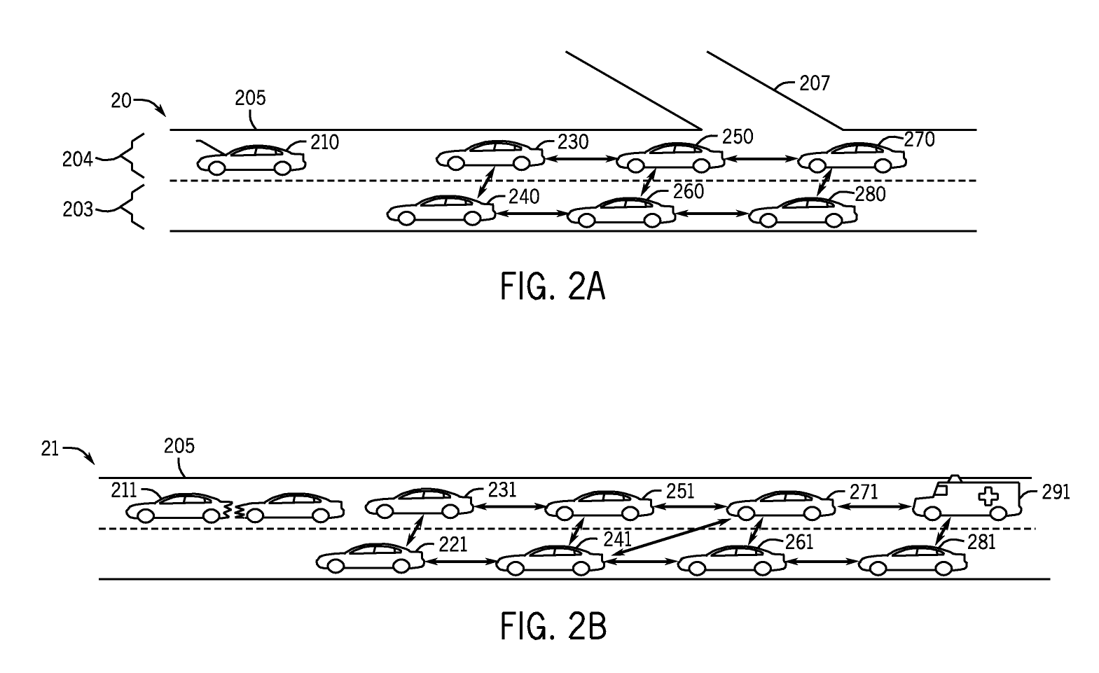

Referring now to FIG. 2A, an example 20 of using an ad hoc wireless network for sharing road information is depicted in accordance with one or more embodiments. In this example, nodes 230, 240, 250, 260, 270, and 280 are travelling on a highway 205, and are connected by an ad hoc wireless network (indicated by arrows). Assume that the nodes shown in FIG. 2A are equivalent to the nodes 160 shown in FIG. 1, and include the same components and functionality described above with reference to nodes 160.

As shown in FIG. 2A, the highway 205 may have two lanes, a right lane 203 and a left lane 204, both for travel in the same direction. In this example, an obstruction 210 is present at a particular location or portion of the highway 205. The obstruction 210 may represent anything affecting the flow of traffic, such as a group of slow and/or stopped vehicles, an oil spill, an ice patch, a fallen tree, a construction site, a vehicle suffering a mechanical breakdown, etc. In one or more embodiments, as node 230 approaches the obstruction 210, one or more sensors 159 of node 230 may detect the obstruction 210. For example, the sensor(s) 159 may detect a vehicle or object blocking the right lane 203, a drop in average speed of vehicles at the particular location, a loss in traction, etc.

In response to detecting the obstruction 210, node 230 may send information about the obstruction 210 to the other nodes using the ad hoc wireless network. Such information may include, e.g., location, speed, video or still images, a text description, or any other indication of the obstruction 210. Upon receiving the information from node 230, each receiving node (e.g., node 250) may present the information (or an indication based on the information) to a user of the receiving node (e.g., a driver). The drivers of the receiving nodes may then adjust their driving based on the received information. For example, a driver may change lanes to avoid the obstruction 210. In another example, a driver may slow a driving speed before reaching an ice patch. In yet another example, the driver of node 270 may avoid the obstruction 210 by detouring off the highway 205 onto a side road 207.

In one or more embodiments, one or more nodes shown in FIG. 2A may determine a traffic flow plan to move around the obstruction 210. For example, node 230 may generate a traffic flow plan specifying that groups of vehicles from the two lanes are to use a single unobstructed lane in alternating turns. Such a traffic control plan may be based on quantities of vehicles (e.g., ten vehicles from left lane 204, then ten vehicles from right lane 203, etc.), periods of time (e.g., fifty seconds allocated to left lane 204, then forty seconds allocated to right lane 203, etc.), any combination of quantities and time periods, and/or any other parameters. The traffic control plan may be based on one or more predefined algorithms for traffic control. The traffic control plan may be sent to each vehicle affected by the obstruction 210 (e.g., nodes 240, 250, 260, etc.). Optionally, in one or more embodiments, the traffic control plan may be generated cooperatively by the nodes included in the ad hoc wireless network.

Further, in one or more embodiments, the driver of each vehicle may be presented with the traffic control plan (or information derived from the traffic control plan) in order to move around the obstruction. For example, each driver may receive an indication on a display device (e.g., a green light and red light display, a text message, an auditory signal, etc.) to determine whether to stop or go into an available lane around the obstruction 210. In this manner, the flow around the obstruction may be controlled in a manner similar to that provided by a traffic policeman, and may thereby reduce the delay to each vehicle.

Referring now to FIG. 2B, an example 21 of using an ad hoc wireless network in emergency response situations is depicted in accordance with one or more embodiments. In this example, nodes 221, 231, 241, 251, 261, 271, and 281 are travelling on highway 205, and are connected by an ad hoc wireless network (indicated by arrows). Assume that the nodes shown in FIG. 2B are equivalent to the nodes 160 shown in FIG. 1, and include the same components and functionality described above with reference to nodes 160.

As shown in FIG. 2B, an accident 211 (e.g., a multi-vehicle collision, a vehicle-pedestrian collision, etc.) has occurred at a particular location on the highway 205. Assume that an emergency service has been called in response to the accident 211, and therefore an emergency response vehicle 291 (e.g., an ambulance, a fire truck, a police car, etc.) is travelling toward the site of the accident 211.

In one or more embodiments, the emergency response vehicle 291 may receive information related to the accident 211 from any nodes in the vicinity of the accident 211. For example, the emergency response vehicle 291 may receive images of the accident 211 from node 231. Such images may have been captured by a sensor 159 (e.g., a camera) of node 231, and may have been sent by node 231 using the ad hoc wireless network. The information received by the emergency response vehicle 291 may also include, e.g., location, speed, video, a text description, or any other indication of the accident 211. Such information may enable personnel of the emergency response vehicle 291 to assess the accident 211 and to prepare before arriving at the site of the accident 211.

In one or more embodiments, personnel in the emergency response vehicle 291 may use the ad hoc wireless network to send instructions to the nodes. For example, such instructions may include a request to keep a particular lane clear for the emergency response vehicle 291, a request for additional information about the accident (e.g., request an image of a particular location or from a particular perspective), a request to administer first aid to an injured person, etc.

Note that the examples shown in FIGS. 1 and 2A-2B are provided for the sake of illustration, and are not intended to limit embodiments of the invention. For example, embodiments of the invention may include any number and arrangement of nodes. Further, it is contemplated that ad hoc wireless networks may be established using any number of intermediate nodes, and may also connect to external communications networks. For example, any of the nodes may also connect to an access point (not shown) to access another network (e.g., the Internet). It is also contemplated that the nodes may act as network relays for each other, thereby enabling a node to access an external network without being directly connected to an access point.

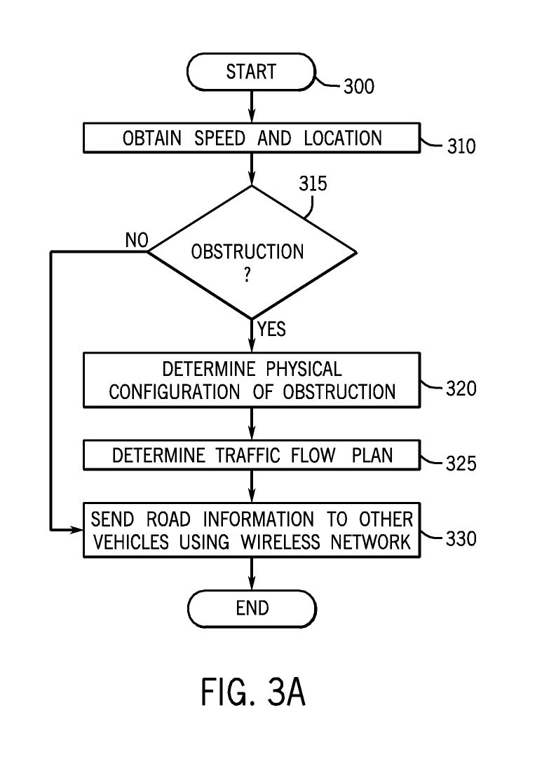

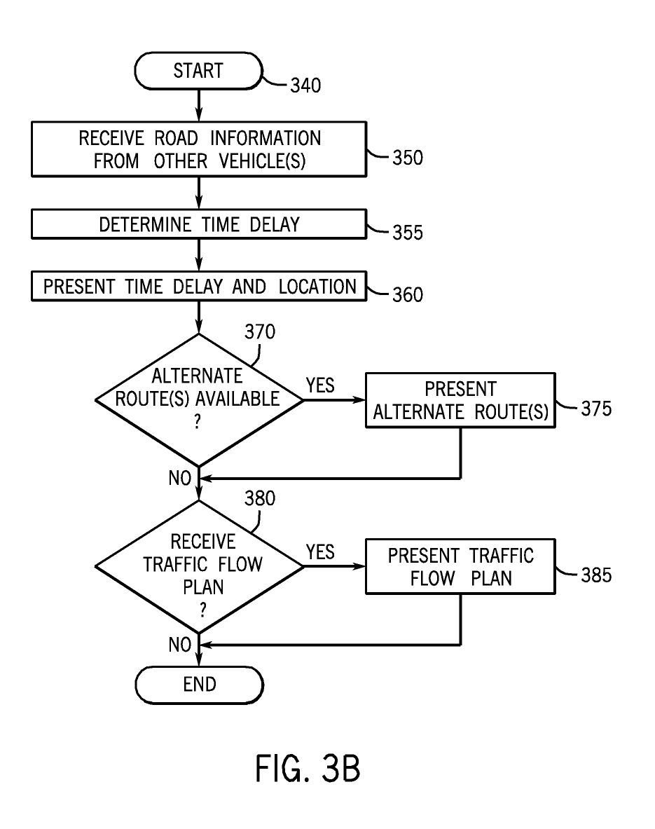

FIG. 3A shows a sequence 300 for obtaining road information in accordance with one or more embodiments. The sequence 300 may be implemented in hardware, software, and/or firmware. In firmware and software embodiments it may be implemented by computer executed instructions stored in a non-transitory computer readable medium, such as an optical, semiconductor, or magnetic storage device. In one embodiment, the sequence 300 may be part of the road information module 158 shown in FIG. 1. In another embodiment, the sequence 300 may be implemented by any other component of a node 160.

At step 310, speed and location information may be obtained by a node. For example, referring to FIGS. 1 and 2A, node 230 may obtain the average speed of traffic at a particular location on highway 205. In one or more embodiments, such speed and location information may be provided by sensor(s) 159 (e.g., a GPS device, an onboard trip computer, a speedometer, etc.) included in the node 230.

At step 315, a determination may be made about whether there is an obstruction in a road. For example, referring to FIG. 2A, node 230 may use sensor(s) 159 to detect the obstruction 210 in highway 205. If it is determined that there is no obstruction, then at step 330, the road information about speed and location (obtained at step 310) is sent to other vehicles using the ad hoc wireless network. For example, referring to FIG. 2A, node 230 may send information about average speed of traffic at a particular location on highway 205 to node 250.

However, if it is determined at step 315 that there is an obstruction, then at step 320, the physical configuration of the obstruction may be determined. For example, referring to FIG. 2A, node 230 may use on-board sensors 159 to determine the physical configuration (e.g., size, shape, location, etc.) of the obstruction 210 and the surrounding area.

At step 325, a traffic flow plan may be determined. For example, referring to FIG. 2A, node 230 may determine a traffic flow plan specifying that three vehicles in the left lane 204 (e.g., nodes 240, 260, and 280) are to pass around the obstruction 210 first, followed by three vehicles in the right lane 203 (e.g., nodes 230, 250, and 270). Optionally, the traffic flow plan may be determined by a vote of a group of nodes.

Next, at step 330, the road information about speed and location (obtained at step 310) and the traffic flow plan (determined at step 325) may be sent to other vehicles using the ad hoc wireless network. For example, referring to FIG. 2A, node 230 may send road information and a traffic flow plan to nodes 240, 250, 260, 270, and 280. After step 330, the sequence 300 ends.

FIG. 3B shows a sequence 340 for receiving and using road information in accordance with one or more embodiments. The sequence 340 may be implemented in hardware, software, and/or firmware. In firmware and software embodiments it may be implemented by computer executed instructions stored in a non-transitory computer readable medium, such as an optical, semiconductor, or magnetic storage device. In one embodiment, the sequence 340 may be part of the road information module 158 shown in FIG. 1. In another embodiment, the sequence 340 may be implemented by any other component of a node 160.

At step 350, road information may be received from other vehicles in an ad hoc wireless network. For example, referring to FIG. 2A, node 250 may receive road information (e.g., average speed at a given location, information about an obstruction, etc.) from node 230.

At step 355, an estimated time delay may be determined using the received road information. At step 360, the estimated time delay may be presented to a driver of the vehicle. For example, referring to FIG. 2A, node 270 may use information received from node 230 to determine an estimated time delay due to current road conditions, and may present the estimated time delay to a user of node 270.

At step 370, a determination may be made about whether there any alternate routes available. If not, then the sequence 340 continues at step 380 (described below). However, if it is determined at step 370 that there are alternate routes available, then at step 375, the alternate routes may be presented to a driver. For example, referring to FIGS. 1 and 2A, node 270 may use sensor(s) 159 (e.g., an navigational computer, a GPS device, etc.) to determine that side road 207 is an alternate route to the highway 205. Thus, the node 270 may interact with a display device to present the alternate route to the driver of node 270. In one or more embodiments, an alternate route may be optionally presented based on the estimated time delay (determined at step 355).

At step 380, a determination may be made about whether a traffic flow plan has been received. If not, then the sequence 340 ends. However, if it is determined at step 380 that a traffic flow plan has been received, then at step 385, the traffic flow plan may be presented to a driver. For example, referring to FIG. 2A, node 270 may determine that a traffic flow plan for obstruction 211 has been received from node 230. Thus, the node 270 may interact with a display device to present the traffic flow plan to the driver of node 270. After step 385, the sequence 340 ends.

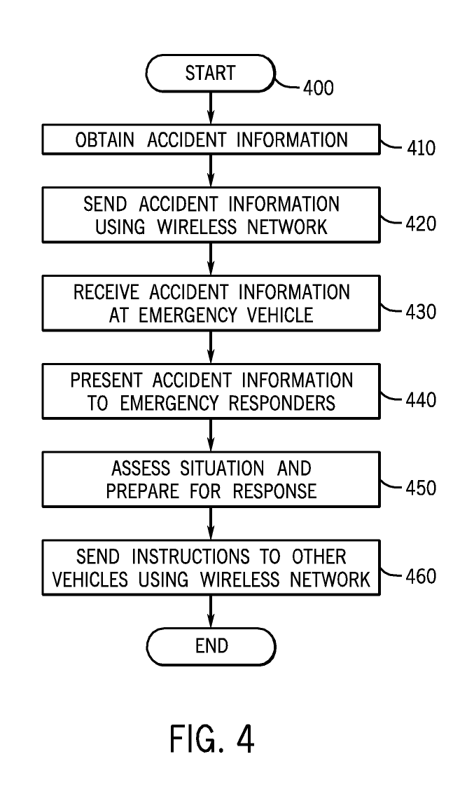

FIG. 4 shows a sequence 400 for sharing information in emergency situations in accordance with one or more embodiments. The sequence 400 may be implemented in hardware, software, and/or firmware. In firmware and software embodiments it may be implemented by computer executed instructions stored in a non-transitory computer readable medium, such as an optical, semiconductor, or magnetic storage device. In one embodiment, the sequence 400 may be part of the road information module 158 shown in FIG. 1. In another embodiment, the sequence 400 may be implemented by any other component of a node 160.

At step 410, information about an accident may be obtained by a node. For example, referring to FIGS. 1 and 2B, node 230 may obtain information about accident 211. The information about the accident 211 may include, e.g., location, position, vehicle condition, number of people involved, type and severity of injuries, etc. In one or more embodiments, such accident information may be obtained using sensor(s) 159 (e.g., a video camera, a radar sensor, an infrared sensor, etc.) included in the node 230. Optionally, the accident information may also be entered by a user using an interface of node 230 (e.g., a keyboard, voice interface, graphic interface, mouse, joystick, etc.)

At step 420, the accident information may be sent to other vehicles using the ad hoc wireless network. At step 430, the accident information may be received by an emergency response vehicle. For example, referring to FIG. 2B, information about the accident 211 (obtained at step 410) is sent by node 230 using the ad hoc wireless network, and is received by the emergency response vehicle 291.

At step 440, the accident information may be presented to emergency responders. At step 450, the emergency responders may use the accident information to assess the accident, and to prepare to respond to the accident. For example, referring to FIG. 2B, personnel of the emergency response vehicle 291 may be presented with information about the accident 211, and may use such information to prepare to respond to the accident 211. Such preparation may include, e.g., gathering required medical supplies, retrieving information about a particular type of vehicle, etc.

At step 460, the emergency responders send instructions to other vehicles using the ad hoc wireless network. For example, referring to FIG. 2B, personnel of the emergency response vehicle 291 may send instructions to nodes 221, 231, 241, 251, 261, 271, and 281. Examples of such instructions may include a request to keep a particular lane clear for the emergency response vehicle 291, requests for images or descriptions of the accident, instructions for administering first aid to an injured person at the accident site, etc. After step 460, the sequence 400 ends.

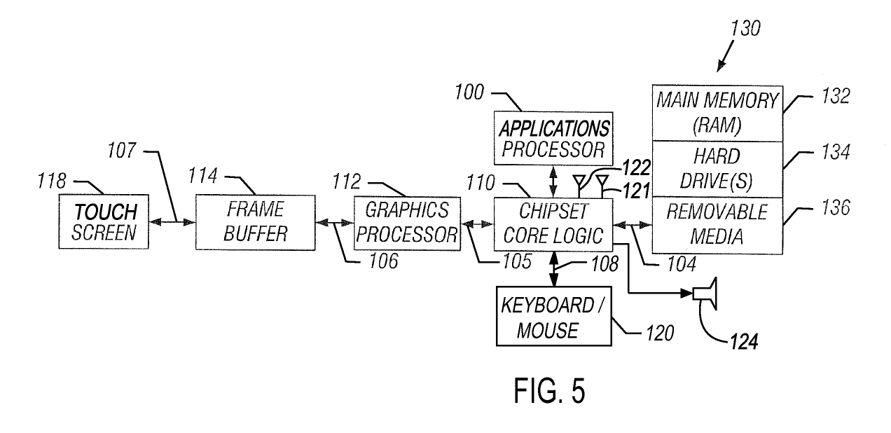

FIG. 5 depicts a computer system 130, which may be the nodes 160 shown in FIG. 1. The computer system 130 may include a hard drive 134 and a removable medium 136, coupled by a bus 104 to a chipset core logic 110. A keyboard and mouse 120, or other conventional components, may be coupled to the chipset core logic via bus 108. The core logic may couple to the graphics processor 112 via a bus 105, and the applications processor 100 in one embodiment. The graphics processor 112 may also be coupled by a bus 106 to a frame buffer 114. The frame buffer 114 may be coupled by a bus 107 to a display screen 118, such as a liquid crystal display (LCD) touch screen. In one embodiment, a graphics processor 112 may be a multi-threaded, multi-core parallel processor using single instruction multiple data (SIMD) architecture.

The chipset logic 110 may include a non-volatile memory port to couple the main memory 132. Also coupled to the logic 110 may be a radio transceiver and antenna(s) 121, 122. Speakers 124 may also be coupled through logic 110.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. For example, it is contemplated that the functionality described above with reference to any particular component or module may be included in any other component or module (or any combinations thereof). It is intended that the appended claims cover all such modifications and variations as fall within the true spirit and scope of this present invention.

What is claimed is:

1. A method comprising:
obtaining road information using sensors of a first vehicle; and
sending the road information to a plurality of other vehicles using an ad hoc wireless network.

2. The method of claim 1 wherein obtaining the road information comprises determining an average speed for a particular portion of a road.

3. The method of claim 1 wherein obtaining the road information comprises determining a location of an obstruction in a road.

4. The method of claim 3 wherein obtaining the road information further comprises determining a physical configuration of the obstruction.

5. The method of claim 1 wherein obtaining the road information comprises capturing at least one image of an accident.

6. The method of claim 1 further comprising determining a traffic flow plan for an obstruction in a road.

7. The method of claim 1 further comprising receiving the road information at a second vehicle of the plurality of vehicles.

8. The method of claim 7 further comprising, based on the received road information, presenting an average speed for a particular portion of a road to a driver of the second vehicle.

9. The method of claim 7 further comprising, based on the received road information, presenting a location of an obstruction in a road to a driver of the second vehicle.

10. The method of claim 9 further comprising, based on the received road information, presenting a traffic flow plan for the obstruction to a driver of the second vehicle.

11. The method of claim 7 further comprising, based on the received road information, presenting an alternate route to a driver of the second vehicle.

12. The method of claim 7 further comprising, prior to receiving the road information at the second vehicle:
receiving the road information at a third vehicle of the plurality of vehicles; and
sending the road information from the third vehicle to the second vehicle.

13. The method of claim 1 further comprising:
establishing an ad hoc wireless network to connect the plurality of vehicles.

14. The method of claim 13 wherein establishing the ad hoc wireless network is based on speeds and directions of the plurality of the vehicles.

15. The method of claim 1 further comprising receiving the road information at an emergency response vehicle of the plurality of vehicles, wherein the road information comprises information about an accident.

16. The method of claim 15 further comprising presenting the information about the accident to personnel of the emergency response vehicle.

17. The method of claim 16 further comprising:
receiving instructions from the personnel of the emergency response vehicle; and
sending the instructions to drivers of other vehicles using the ad hoc wireless network.

18. The method of claim 17 wherein sending the instructions comprises sending a command to clear a particular lane of the road for the emergency response vehicle.

19. The method of claim 17 wherein sending the instructions comprises sending first aid instructions.

20. A non-transitory computer readable medium storing instructions to cause a computer to:
establish an ad hoc wireless network comprising a plurality of vehicles;
obtain road information using sensors of a first vehicle of the plurality of vehicles; and
send the road information to other vehicles of the plurality of vehicles using the ad hoc wireless network.

21. The medium of claim 20 further storing instructions to establish the ad hoc wireless network based on speed and direction information for the plurality of vehicles.

22. The medium of claim 15 further storing instructions to send an average speed for a particular portion of a road to a second vehicle of the plurality of vehicles.

23. The medium of claim 15 further storing instructions to send a location of an obstruction in a road to a second vehicle of the plurality of vehicles.

24. The medium of claim 15 further storing instructions to determine a traffic flow plan for an obstruction in a road in cooperation with at least one of the plurality of vehicles.

25. A mobile device comprising:
at least one sensor;
a wireless transceiver; and
a controller coupled to the wireless transceiver, the controller to:
obtain road information using the at least one sensor; and
send the road information to a plurality of vehicles using an ad hoc wireless network.

26. The mobile device of claim 25 wherein the controller is also to connect to the ad hoc wireless network.

27. The mobile device of claim 25 wherein the controller is also to determine a traffic flow plan for an obstruction in a road.

28. The mobile device of claim 25 wherein the controller is also to receive inbound road information from a second vehicle of the plurality of vehicles.

29. The mobile device of claim 28 wherein the controller is also to present a user of the mobile device with the inbound road condition information received from the second vehicle.

30. The mobile device of claim 25 wherein the controller is also to present a user of the mobile device with instructions from emergency response personnel.
